(19) United States
(12) Patent Application Publication
(10) Pub. No.: US 2025/0374102 A1
(43) Pub. Date: Dec. 4, 2025

(54) USER EQUIPMENT INITIATED CROSS-LINK INTEFERENCE (CLI) REPORTING

(71) Applicant: Lenovo (United States) Inc., Morrisville, NC (US)

(72) Inventor: Khaled Nafez Rauf ARDAH, Ilmenau (DE)

(21) Appl. No.: 19/294,803

(22) Filed: Aug. 8, 2025

(51) Int. Cl. H04W 24/10; H04W 72/1268; H04W 72/232

(52) U.S. Cl. CPC H04W 24/10; H04W 72/1268; H04W 72/232

(57) ABSTRACT

Various aspects of the present disclosure relate to a user equipment (UE) being enabled to control performance of cross-link interference (CLI) reporting procedures, such as via UE-initiated and/or event-driven CLI reporting procedures. For example, a victim UE identifies and/or determines occurrences of CLI events at or associated with the UE and requests resources (e.g., resources associated with uplink (UL) grants) for sending CLI reports in response to the CLI events (e.g., CLI report triggering events).

### TECHNICAL FIELD

The present disclosure relates to wireless communications, and more specifically to cross-link interference (CLI) reporting initiated by a user equipment (UE).

### BACKGROUND

A wireless communications system may include one or multiple network communication devices, which may be otherwise known as network equipment (NE), supporting wireless communications for one or multiple user communication devices, which may be otherwise known as UEs, or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that provide and/or support UE-initiated CLI reporting, such as CLI reporting in response to occurrences and/or predictions of CLI events (e.g., UE-to-UE CLI) associated with a UE.

A UE for wireless communication is described. The UE may be configured to, capable of, or operable to perform one or more operations as described herein. For example, the UE may comprise at least one memory and at least one processor coupled with the at least one memory and configured to cause the UE to determine an occurrence of a CLI report event, transmit, in response to the occurrence of the CLI report event, a message to request an uplink (UL) grant, receive downlink control information (DCI) that schedules resources for the UL grant; and transmit a CLI report over the resources scheduled for the UL grant.

A processor for wireless communication is described. The processor may be configured to, capable of, or operable to perform one or more operations as described herein. For example, the processor may comprise at least one memory and at least one controller coupled with the at least one memory and configured to cause the processor to determine an occurrence of a CLI report event, transmit, in response to the occurrence of the CLI report event, a message to request a UL grant, receive DCI that schedules resources for the UL grant; and transmit a CLI report over the resources scheduled for the UL grant.

A method performed or performable by the UE is described. The method may comprise determining an occurrence of a CLI report event, transmitting, in response to the occurrence of the CLI report event, a message to request a UL grant, receiving DCI that schedules resources for the UL grant; and transmitting a CLI report over the resources scheduled for the UL grant.

In some implementations of the UE, processor, and method described herein, the message includes a scheduling request message or a scheduling request indicator.

In some implementations of the UE, processor, and method described herein, the UE, processor, and method may further be configured to, capable of, performed, performable, or operable to receive a configuration from a network entity, wherein the configuration includes: an indication of one or more CLI measurement resources, an indication of one or more CLI reporting procedure event trigger conditions, or an indication of one or more UL resources for transmitting the message to request the UL grant.

In some implementations of the UE, processor, and method described herein, the UE, processor, and method may further be configured to, capable of, performed, performable, or operable to receive the configuration from the network entity via DCI, a media access control-control element (MAC-CE), or radio resource control (RRC) signaling.

In some implementations of the UE, processor, and method described herein, the configuration identifies: one or more CLI measurements to be performed by the UE, a time offset relative to receiving the configuration from the network entity, and time and frequency resources for which the one or more CLI measurements are to be performed.

In some implementations of the UE, processor, and method described herein, the configuration includes: a configuration associated with CLI reporting for sub-band full-duplex (SBFD) symbols and a configuration associated with CLI reporting for non-SBFD symbols.

In some implementations of the UE, processor, and method described herein, the UE is configured with CLI prediction measurement resources, and the UE, processor, and method may further be configured to, capable of, performed, performable, or operable to determine the occurrence of the CLI report event when another UE is within a threshold distance from the UE.

In some implementations of the UE, processor, and method described herein, the CLI prediction measurement resources include side-link positioning reference signal (SL-PRS) measurement resources or sensing-based measurement resources.

In some implementations of the UE, processor, and method described herein, the UE, processor, and method may further be configured to, capable of, performed, performable, or operable to determine another UE is within the threshold distance from the UE by performing position-based measurements associated with the another UE.

In some implementations of the UE, processor, and method described herein, the UE, processor, and method may further be configured to, capable of, performed, performable, or operable to transmit the message to request the UL grant via a dedicated scheduling request (SR) message, dedicated uplink control information (UCI), or a dedicated physical random access channel (PRACH) preamble.

In some implementations of the UE, processor, and method described herein, the CLI report event includes: a CLI measurement level is above a configured threshold measurement level, a CLI measurement level is below a configured threshold measurement level, a CLI measurement level is an offset above a configured threshold measurement level, a CLI measurement level is an offset below a configured threshold measurement level, a distance between the UE and an aggressor UE is above a configured threshold distance, or a distance between the UE and an aggressor UE is below a configured threshold distance.

In some implementations of the UE, processor, and method described herein, the UE, processor, and method may further be configured to, capable of, performed, performable, or operable to determine the occurrence of the CLI report event when one or more CLI measurement levels associated with CLI measurement occasions satisfy one or more conditions associated with the CLI report event within a configured measurement window.

In some implementations of the UE, processor, and method described herein, the CLI report includes: a corresponding event index, one or more corresponding CLI measurement indexes, or one or more quantized CLI measurement levels.

A network entity for wireless communication is described. The network entity may be configured to, capable of, or operable to perform one or more operations as described herein. For example, the network entity may comprise at least one memory and at least one processor coupled with the at least one memory and configured to cause the network entity to receive a message from a UE to request a UL grant for an event-triggered CLI report, transmit DCI that schedules resources for the UL grant, and receive the event-triggered CLI report over the resources scheduled for the UL grant.

A method performed or performable by the network entity is described. The method may comprise receiving a message from a UE to request a UL grant for an event-triggered CLI report, transmitting DCI that schedules resources for the UL grant, and receiving the event-triggered CLI report over the resources scheduled for the UL grant.

In some implementations of the network entity and method described herein, the resources for the UL grant include physical uplink shared channel (PUSCH) resources or physical uplink control channel (PUCCH) resources.

In some implementations of the network entity and method described herein, the DCI includes a dedicated indicator field that indicates the scheduled resources for the UL grant.

In some implementations of the network entity and method described herein, the DCI includes a dedicated channel state information (CSI) request field that is associated with a dedicated CSI trigger state and that indicates the scheduled resources for the UL grant.

In some implementations of the network entity and method described herein, the network entity and method may further be configured to, capable of, performed, performable, or operable to receive the message to request the UL grant via a dedicated SR message, dedicated UCI, or a dedicated PRACH preamble.

### BRIEF DESCRIPTION OF THE DRAWINGS

FIG. 1 illustrates an example of a wireless communications system in accordance with aspects of the present disclosure.

FIG. 2 illustrates a signaling diagram between a UE and an NE in accordance with aspects of the present disclosure.

FIGS. 3A-3C illustrate UE-initiated CLI reporting procedures in accordance with aspects of the present disclosure.

FIG. 4 illustrates a prohibition window for a CLI reporting procedure in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

The present disclosure relates to methods, apparatuses, and systems that provide, support, implement, and/or introduce UE-initiated CLI reporting procedures, such as CLI reporting procedures that are reactive to CLI triggering events at or measured by a UE, such as a victim UE that is experiencing CLI from one or more aggressor UEs.

Often, CLI occurs or is caused due to different time-division duplex (TDD) downlink-uplink (DL-UL) patterns are utilized between multiple neighboring cells and/or when SBFD operations are used within one or multiple neighboring cells. There may be CLI between gNodeBs (gNBs) or other cells, such as gNB-to-gNB CLI (e.g., a DL transmission from an aggressor gNB may interfere with UL reception at a victim gNB), CLI between UEs, such as UE-to-UE CLI (e.g., a UL transmission by an aggressor UE may interfere with a DL reception at a victim UE), and so on.

While there are schemes that attempt to mitigate UE-to-UE CLI, such as layer 1 (L1) based measurements, such schemes have failed to sufficiently prevent UE-to-UE CLI. For example, CLI between UEs can be random and unpredictable due to aggressor UEs being unknown and/or the mobility of UEs (e.g., a victim UE may measure and report a high level of UE-to-UE CLI from an aggressor UE in one slot, but the UE-to-UE CLI may disappear in a next slot due to mobility of the victim UE and/or one or more aggressor UEs). Such issues lead to high bit error rates (BERs) and inefficient resource utilization for a wireless communications system.

Current CLI reporting procedures may assist in reducing or mitigating CLI between UEs but exhibit significant drawbacks and/or tradeoffs. For example, periodic UE-to-UE CLI reporting can solve for the randomness and unpredictability of UE-to-UE CLI but introduces large uplink resource/feedback overheads and high UE energy consumption, among other drawbacks. However, the use of aperiodic UE-to-UE CLI reporting may not assist in the randomness, unpredictability, and/or mobility issues intrinsic in UE-to-UE CLI, since a victim UE may not be aware of when UE-to-UE CLI occurs, and thus the wireless communications system may be limited in accurately configuring aperiodic UE-to-UE CLI reporting resources.

The technology described herein enables a UE (e.g., a victim UE) to control performance of CLI reporting procedures, such as via UE-initiated and/or event-driven CLI reporting procedures. For example, a victim UE identifies and/or determines occurrences of CLI events at or associated with the UE and requests resources (e.g., resources associated with UL grants) for sending CLI reports in response to the CLI events (e.g., CLI report triggering events).

Thus, the technology may provide a UE that is experiencing UE-to-UE CLI to control the measuring and reporting of CLI in a dynamic and responsive manner. In doing so, the wireless communications system may minimize issues associated with periodic or aperiodic CLI reporting, and provide quick and efficient mitigation procedures for detecting, measuring, and/or reporting CLI, among other benefits.

Aspects of the present disclosure are described in the context of a wireless communications system.

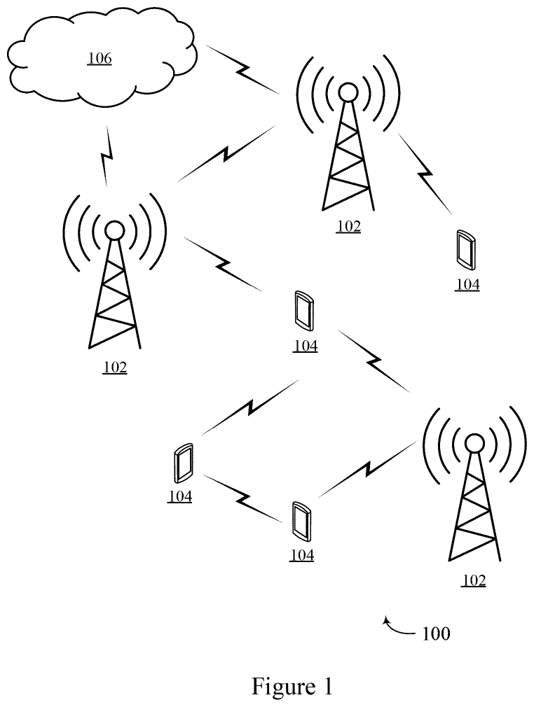

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 or FR2-1 (24.25 GHz-52.6 GHZ), FR3 (7.125 GHZ-24.25 GHZ), FR4 (52.6 GHz-114.25 GHZ), FR4a or FR4-1 or FR2-2 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

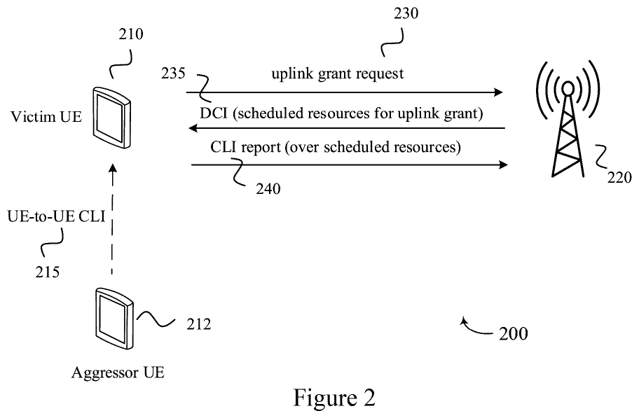

As described herein, the wireless communications system 100 may introduce and/or implement UE-initiated and/or event-triggered CLI reporting for the UE 102 (e.g., a victim UE). FIG. 2 illustrates a signaling diagram 200 between a UE 210 and an NE 220 in accordance with aspects of the present disclosure.

The UE 210 (e.g., a victim UE) may be configured to initiate/trigger/transmit a UE-to-UE L1-based CLI report to the NE (e.g., a serving network node, such as a gNB). For example, the UE 210 may receive a configuration message via RRC signaling, a MAC-CE, DCI), and so on. The configuration may include or indicate measurement resources for which the UE 210 measures UE-to-UE CLI 215 (e.g., levels of CLI) due to one or more aggressor UEs 212.

The configuration may also indicate one or more events associated with monitoring CLI levels and/or triggering a CLI reporting procedure in response to occurrences of certain events and/or determining threshold CLI conditions, as described herein. For example, in response to a determined occurrence of a CLI reporting event, the UE 210 transmits a UL grant request 230 to the NE 220. In response, the NE 220 transmits DCI 235 that contains scheduled resources for the requested UL grant. The UE 210 then transmits a CLI report 240 to the NE 220 using the scheduled resources. Thus, the UE 210, once triggered, transmits the CLI report 240 over the scheduled/configured UL resources (e.g., resources scheduled in response to the UE 210 detecting or determining a CLI reporting event or condition).

In some cases, the scheduled/configured resources (e.g., configured for CLI measurement) provide the UE 210 with (1) which CLI measurements (e.g., sounding reference signal-reference signal received power (SRS-RSRP), CLI-received signal strength indicator (CLI-RSSI), and so on) to be monitored and/or measured, (2) when to start performing CLI measurements (e.g., time offsets relative to receiving configuration messages), and/or (3) where to perform CLI measurements (e.g., time-and-frequency resources for each measurement occasion/resource).

In some cases, information elements (IEs) may provide the resources for performing the CLI measurements. The IEs may include:
An SRS-RSRP-MeasurementResourceSet IE containing one or more of SRS-RSRP measurement resource sets (e.g., SRS-RSRP-MeasurementResource) via which the UE 210 may use when performing L1 SRS-RSRP measurements, and/or
A CLI-RSSI-MeasurementResourceSet IE containing one or more of CLI-RSSI measurement resource sets (e.g., CLI-RSSI-MeasurementResource) via which the UE 210 may use when performing L1 CLI-RSSI measurements; and so on.

In some cases, the configuration may include and/or indicate a periodicity indicator (e.g., expressed in time (e.g., milliseconds) or in a number of symbols/slots) that indicates to the UE 210 how often the CLI measurement resources are to be repeated during CLI measurement and/or reporting.

For certain operations, such as the SBFD operations, the configuration may include separate or unique configurations for various symbol types. For example, the UE 210 may be configured with a first configuration for non-SBFD symbols and a second configuration for SBFD symbols, where the UE 210, based on the separate/unique configurations, may separately monitor, measure, and/or report CLI levels for each symbol type based on the associated configurations.

The UE 210, in some cases, may ignore measurement occasions that (partially) fall across or are associated with two symbol types and/or with symbol types not indicated as valid symbol types. For example, the UE 210 may receive an indication (via the configuration) that SBFD symbols are valid symbols for CLI reporting and ignore measurement occasions associated with non-SBFD symbols (or vice versa).

Thus, a victim UE (e.g., the UE 210) may perform CLI reporting procedures that are specific to a CLI scenario based on an operational mode. In a first scenario, where the UE is 210 operating in a TDD mode/full DL or non-SBFD slot, the UE 210 may be configured to measure CLI-RSSI or SRS-RSRP (e.g., wideband/subband) using CLI measurement resources configured within an active DL-bandwidth part (BWP).

In a second scenarios, where the UE is 210 operating in an SBFD mode, the UE 210 may be configured to measure CLI-RSSI or SRS-RSRP (e.g., wideband/subband) using CLI measurement resources configured within configured DL and/or UL subbands (SBs) and/or guard-bands (GBs). Thus, the UE 210 may measure the CLI-RSSI or SRS-RSRP within one or more configured DL SBs, UL SB, DL and UL SBs, and/or DL and UL SBs and GBs. In some cases, the configuration may indicate a measurement-type, such as a wideband-based or subband-based measurement type.

In some examples, the UE 210 is configured with one or more CLI prediction measurement resources (e.g., sidelink-positioning reference signal (SL-PRS), measurement resources, and/or sensing-based measurement resources) that are used to capture position-based aggressor measurements (e.g., aggressor-based distance/range/delay and/or azimuth/elevation angle of arrivals (AoAs) or angle of departures (AoDs)) and/or the existence of an aggressor UE (e.g., the aggressor UE 212).

For example, the UE 210 may start measuring a CLI level (e.g., SRS-RSRP/CLI-RSSI) when an aggressor UE (e.g., the aggressor UE 212) is within a distance X meters away (e.g., based on the configuration) from the UE 210. As another example, the UE 210 may determine there is an aggressor UE within X meters away and transmit a scheduling message/indicator (e.g., the UL grant request 230) to inform or request the NE 220 (e.g., a serving network node) to configure/send/schedule the UE 210 with CLI measurement and/or reporting resources. The UE 210 may transmit the scheduling message/indicator (e.g., 1-bit) using a dedicated SR message, dedicated UCI (e.g., a UCI channel), a dedicated PRACH preamble, and so on.

In some examples, the UE 210 transmits the UL grant request 230 in response to an occurrence of one or more CLI monitoring events (e.g., indicated by the configuration), which are used to trigger the CLI report 240 once a CLI condition is met or satisfied. Example CLI conditions or events that may trigger the CLI report 240 include: (1) a CLI measurement level is above/larger than a configured threshold; a CLI measurement level is below/smaller than a configured threshold; (3) a CLI measurement level is an offset above a DL reference signal (RS) or an indicated/activated/configured transmission control indicator (TCI)-state measurement level (e.g., a DL synchronization block (SSB) and/or a DL channel state information-reference signal (CSI-RS)); a CLI measurement level is an offset below a DL RS or an indicated/activated/configured TCI-state measurement level (e.g., a DL SSB and/or a DL CSI-RS); an aggressor UE distance/range is below a configured threshold; an aggressor UE distance/range is above a configured threshold; and so on.

In some cases, a separate CLI monitoring event may be associated with each configured CLI measurement resource. In other cases, each CLI monitoring event is associated with all configured CLI measurement resources and/or all of the configured CLI measurement resources within a set/group.

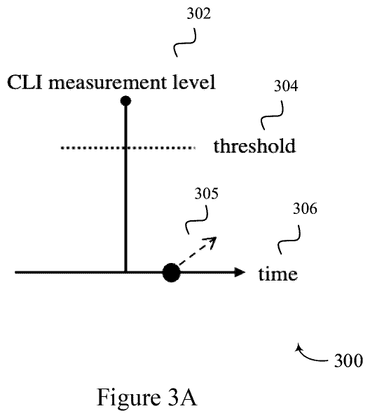

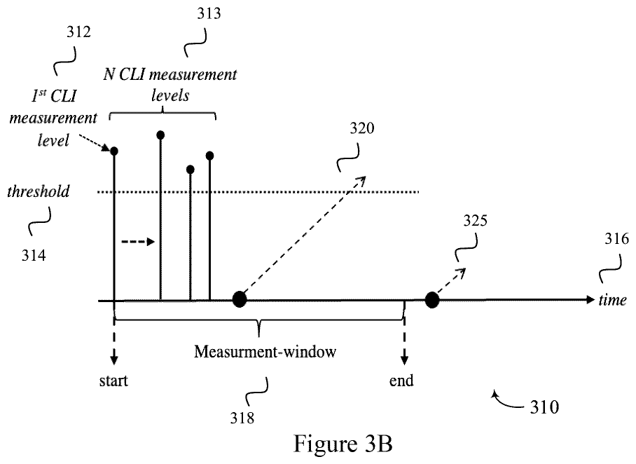

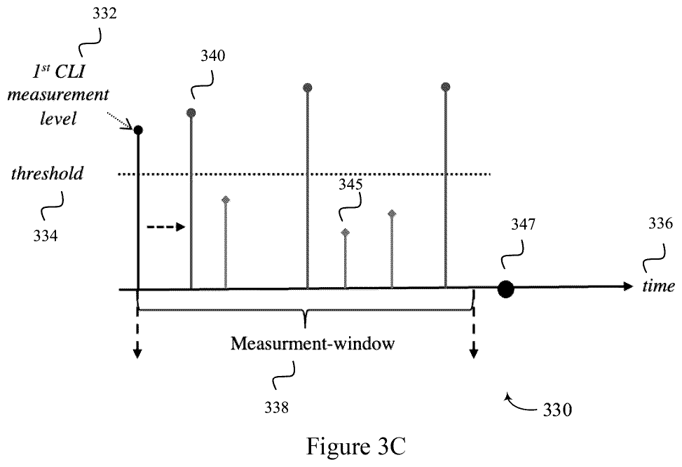

As described herein, a CLI monitoring event may trigger or initiate a CLI reporting procedure when a CLI measurement level meets or satisfies a condition associated with the event. FIGS. 3A-3C illustrate UE-initiated CLI reporting procedures in accordance with aspects of the present disclosure.

FIG. 3A depicts a triggered CLI reporting procedure 300, where a first CLI measurement level 302 exceeds a threshold CLI level 304 (e.g., the triggering condition) within a certain time period 306. Thus, the UE 210 triggers a CLI report (e.g., the CLI report 240) at a time 305 after the condition is met (e.g., the first CLI measurement level 302 exceeds the threshold CLI level 304).

In some cases, the content of the CLI report 240 may include a corresponding event index, a corresponding CLI measurement index, and/or a quantized CLI measurement level. In some cases, the report may include the CLI measurement level that is above/below the configured threshold (e.g., the reported CLI level is relative to the threshold, where the CLI_reported=CLI_measured−threshold).

In some examples, the CLI monitoring event may be associated with a configured/determined measurement-window, a measurement-counter, a filtering method, and so on. The CLI monitoring event may trigger a CLI reporting procedure when CLI measurement levels of corresponding CLI measurement occasions within a configured/determined measurement-window meet or satisfy a triggering condition for the event.

In some examples, the CLI monitoring event triggers a CLI reporting procedure when multiple (e.g., N>=1, where N is indicated in the configuration) CLI measurement levels of corresponding CLI measurement occasions within a configured/determined measurement-window meet the triggering condition for the event. The UE 210 may start a measurement counter and determine the measurement-window once a first CLI measurement level meets the triggering condition. For example, a minimum number of time/symbols between two consecutively counted CLI measurements are equal or larger that a configured threshold.

For example, FIG. 3B depicts a triggered CLI reporting procedure 310 when an N of CLI measurement levels 313, after a first CLI measurement level 312, of corresponding CLI measurement occasions within a measurement-window 318 meet an event triggering condition (e.g., exceed a threshold 314) over time 316. Thus, the UE 210 may trigger CLI reporting procedures (e.g., one or more) during the measurement-window 318. The UE 210 may trigger the CLI reporting procedure once the N of CLI measurement levels 313 of corresponding CLI measurement occasions within the measurement-window 318 meet the triggering condition or after the ending of the measurement-window 318. Thus, the UE 210 may transmit the CLI report at a time 320 within the measurement-window 318 and/or at a time 325 after the ending of the measurement-window 318.

The CLI report (e.g., the CLI report 240) may include a corresponding event index, N corresponding CLI measurement indexes and/or N quantized CLI measurement levels (e.g., a measured or relative-to-threshold approach), including the maximum N CLI measurement levels with respect to the measured CLI levels within the determined measurement-window 318.

In some examples, the measurement-window 318 may be based on a CLI measurement level meeting a triggering condition (e.g., a threshold). FIG. 3C depicts a triggered CLI reporting procedure 330 where a measurement-window 338 begins when a first CLI measurement level 332 exceeds a threshold 334 over a time period 336. The UE 210 may perform/measure CLI levels for corresponding CLI measurement occasions (e.g., measurement occasions 340 that exceed the threshold 334 and/or measurement occasions 345 that do not exceed the threshold 334) within the determined measurement-window 338 and trigger a CLI report after an end to the measurement-window 338 (e.g., at a time 347).

The CLI report (e.g., the CLI report 240) may include a corresponding event index, N>=1 corresponding CLI measurement indexes, and/or N>=1 quantized CLI measurement levels (e.g., a measured, relative-to-threshold approach, and/or or relative to maximum CLI level). In some cases, at least one of the reported N CLI measurement levels satisfy the corresponding event condition (e.g., where N<=N_max and N_max is provided by the configuration and where a zero-padding is added if N is less than N_max).

In some cases, the measurement-window may start when a first CLI measurement level meets a triggering condition and ends when a configured measurement-window length ends and/or when a current periodicity of CLI measurement resources ends.

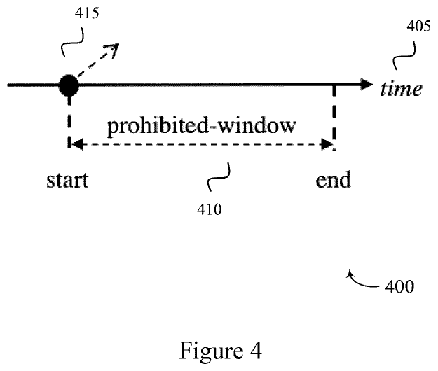

In some examples, the UE 210 may UE stop and/or avoid triggering a CLI reporting procedure for a same or different event within a configured time window. FIG. 4 illustrates a prohibition window 410 for a CLI reporting procedure 400 in accordance with aspects of the present disclosure. The prohibition window 410 (or prohibited-window, backoff window, and so on) may begin at a time 415 when the UE 210 triggers a CLI reporting procedure (and/or transmits a CLI report) and ends after a duration of time 405 configured for the prohibition window 410 (e.g., a configured length of time).

In some cases, the UE 210 may trigger multiple CLI reporting procedures based on a prioritization. For example, the UE 210 may first transmit a CLI report corresponding to a highest priority for the CLI event and/or transmit a CLI report last based on a low priority event. In some cases, CLI events may be associated with different levels of prioritization, where a priority level of each configured event is indicated in the configuration message.

As described herein, once the UE 210 triggers a CLI reporting procedure, the UE 210 may transmit a scheduling request message/indicator (e.g., the UL grant request 230) requesting a serving network node to configure/transmit/schedule the UE 210 with a CLI reporting resource. The UE 210 may transmit the request message/indicator (e.g., 1-bit or 2-bit) using a dedicated SR message/channel, a dedicated indicator in a UCI channel, a dedicated PRACH preamble (e.g., configured via an RRC configuration message), and so on. The serving network node (e.g., the NE 220) may configure a periodic PUCCH/PUSCH resource to the UE 210 or to a group of UEs by a dedicated/common RRC message, which carries the request message/indicator. In some cases, the mapping of request message/indicator bits may indicate the triggering event. In some cases, each event may be associated with a dedicated SR, UCI indicator/resource, and/or a PRACH preamble.

In some cases, the UE 210 receives DCI (e.g., the DCI 235) scheduling the UL grant (e.g., a PUSCH resource) for the UE 210, and the UE 210 may use the scheduled UL grant resources to transmit a CLI measurement report (e.g., the CLI report 240). The DCI may include an indicator (e.g., a dedicated indictor field or a dedicated CSI request field associated with a dedicated CSI trigger state) indicating that the scheduled UL grant is for transmitting an indicated CLI measurement report. In some cases, the UE 210 may retransmit the request message/indicator when the scheduling DCI is not received within a configured time-window/interval (e.g., a backoff time). The UE 210 may retransmit the request message/indicator up to a configured maximum number of times. In some cases, the UE 210 may transmit the CLI report using the scheduled UL grant and may receive an acknowledgement/non-acknowledgment (ACK/NACK) message for the transmitted CLI report from the NE 220.

In some examples, the UE 210 may initially receive a configuration message configuring one or more of periodic UL resources dedicated for CLI reporting, such as Type 1 and/or Type 2 configured grant (CG) PUSCH resources, where the configured UL resources are dedicated for (or associated with) an indicated event index. Once the UE 210 triggers a CLI reporting procedure, the UE 210 may transmit the CLI report using a selected/determined/configured UL resource.

In some examples, the UE 210 may first transmit a notification

message/indicator to notify the serving network node (e.g., the NE 220) that a CLI report is to be transmitted using a configured UL resource. The notification message/indicator (e.g., 1-bit or 2-bit) may be transmitted using an SR message/channel, a dedicated indicator in a UCI channel, and/or a dedicated PRACH preamble. The serving network node may configure one or more periodic PUCCH/PUSCH resources to the UE 210 or to a group of UEs by a dedicated/common RRC message, which carries the notification message/indicator. One or more configured periodic PUCCH/PUSCH resources may be associated with an indicated event index and/or with an indicated UL resource (PUSCH/PUCCH).

The notification message may indicate the selected/determined UL resources used (or to be used) for transmitting the CLI report (e.g., explicitly by indicating an UL resource index or implicitly by association between periodic PUCCH/PUSCH resource and event triggering CLI reporting procedure). The UE 210 may transmit the CLI report using the scheduled UL grant and may receive an ACK/NACK message for the transmitted CLI report from the NE 220.

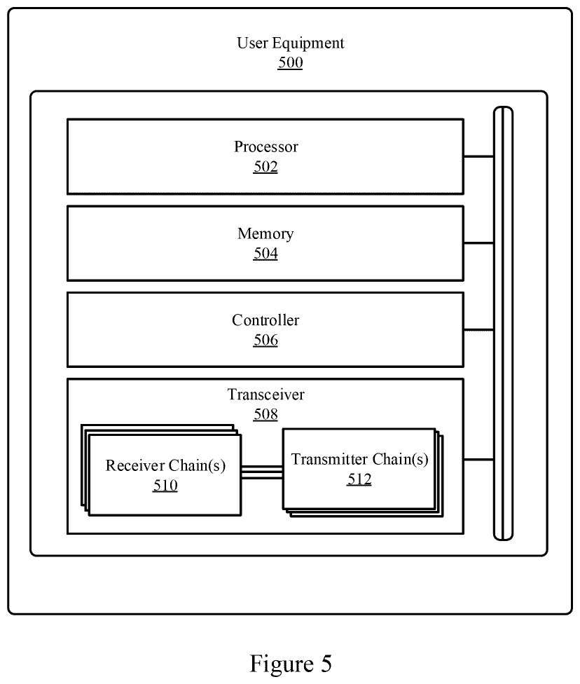

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to support a means for determining an occurrence of a CLI report event, transmitting, in response to the occurrence of the CLI report event, a message to request a UL grant, receiving DCI that schedules resources for the UL grant, and transmitting a CLI report over the resources scheduled for the UL grant.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

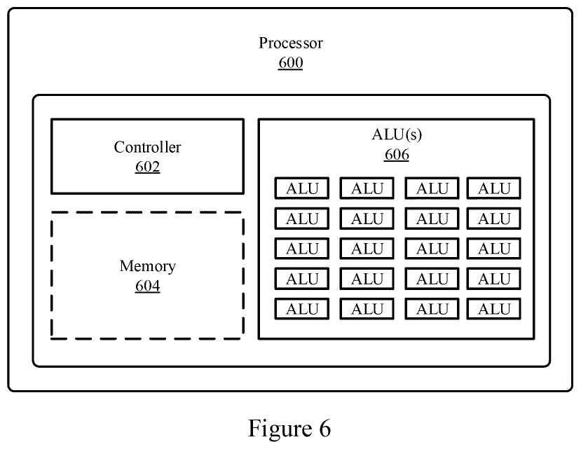

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FcRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support a means for determining an occurrence of a CLI report event, transmitting, in response to the occurrence of the CLI report event, a message to request a UL grant, receiving DCI that schedules resources for the UL grant, and transmitting a CLI report over the resources scheduled for the UL grant.

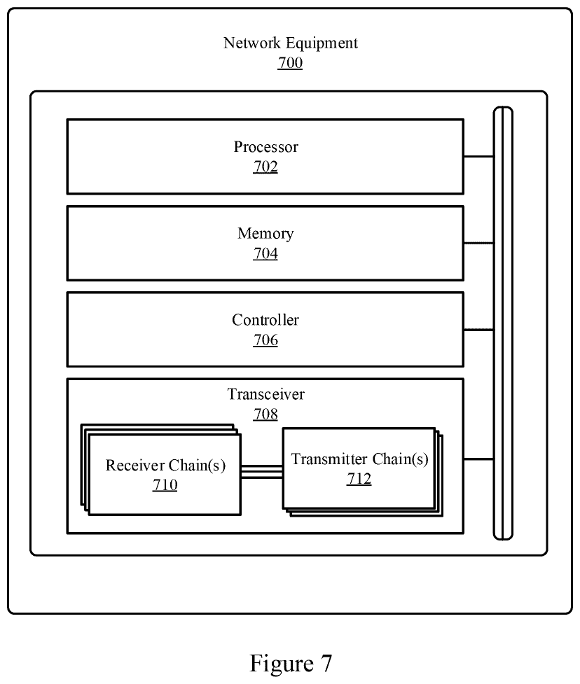

FIG. 7 illustrates an example of a NE 700 in accordance with aspects of the present disclosure. The NE 700 may include a processor 702, a memory 704, a controller 806, and a transceiver 708. The processor 702, the memory 704, the controller 806, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 806, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to support a means for receiving a message from a UE to request a UL grant for an event-triggered CLI report, transmitting DCI that schedules resources for the UL grant, and receiving the event-triggered CLI report over the resources scheduled for the UL grant.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

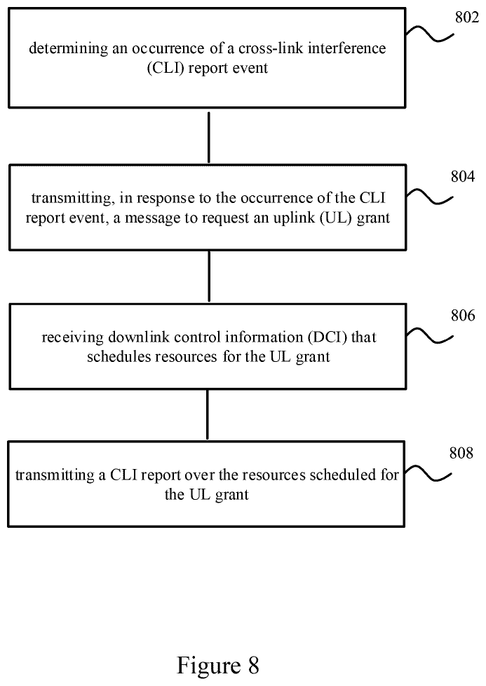

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include determining an occurrence of a CLI report event. The operations of 802 may be performed in accordance with examples as described herein. In some implementations, aspects of the operations of 802 may be performed by a UE as described with reference to FIG. 5.

At 804, the method may include transmitting, in response to the occurrence of the CLI report event, a message to request a UL grant. The operations of 804 may be performed in accordance with examples as described herein. In some implementations, aspects of the operations of 804 may be performed a UE as described with reference to FIG. 5.

At 806, the method may include receiving DCI that schedules resources for the UL grant. The operations of 806 may be performed in accordance with examples as described herein. In some implementations, aspects of the operations of 806 may be performed a UE as described with reference to FIG. 5.

At 808, the method may include transmitting a CLI report over the resources scheduled for the UL grant. The operations of 808 may be performed in accordance with examples as described herein. In some implementations, aspects of the operations of 808 may be performed a UE as described with reference to FIG. 5.

It should be noted that the method described herein describes a possible implementation, and that the operations and the steps may be rearranged or otherwise modified and that other implementations are possible.

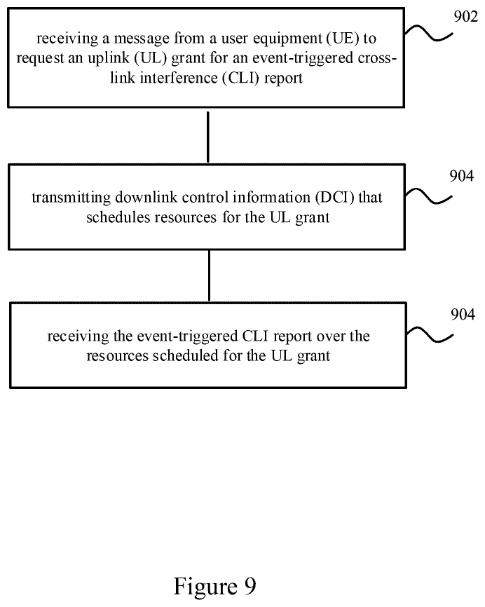

FIG. 9 illustrates a flowchart of a method in accordance with aspects of the present disclosure. The operations of the method may be implemented by an NE as described herein. In some implementations, the NE may execute a set of instructions to control the function elements of the NE to perform the described functions.

At 902, the method may include receiving a message from a UE to request a UL grant for an event-triggered CLI report. The operations of 902 may be performed in accordance with examples as described herein. In some implementations, aspects of the operations of 902 may be performed by an NE as described with reference to FIG. 7.

At 904, the method may include transmitting DCI that schedules resources for the UL grant. The operations of 904 may be performed in accordance with examples as described herein. In some implementations, aspects of the operations of 904 may be performed by an NE as described with reference to FIG. 7.

At 906, the method may include receiving the event-triggered CLI report over the resources scheduled for the UL grant. The operations of 906 may be performed in accordance with examples as described herein. In some implementations, aspects of the operations of 906 may be performed by an NE as described with reference to FIG. 7.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
determine an occurrence of a cross-link interference (CLI) report event;
transmit, in response to the occurrence of the CLI report event, a message to request an uplink (UL) grant;
receive downlink control information (DCI) that schedules resources for the UL grant; and
transmit a CLI report over the resources scheduled for the UL grant.

2. The UE of claim 1, wherein the message includes a scheduling request message or a scheduling request indicator.

3. The UE of claim 1, wherein the at least one processor is configured to cause the UE to:
receive a configuration from a network entity,
wherein the configuration includes:
an indication of one or more CLI measurement resources;
an indication of one or more CLI reporting procedure event trigger conditions; or
an indication of one or more UL resources for transmitting the message to request the UL grant.

4. The UE of claim 3, wherein the at least one processor is configured to cause the UE to receive the configuration from the network entity via DCI, a media access control-control element (MAC-CE), or radio resource control (RRC) signaling.

5. The UE of claim 3, wherein the configuration identifies:
one or more CLI measurements to be performed by the UE;
a time offset relative to receiving the configuration from the network entity; and
time and frequency resources for which the one or more CLI measurements are to be performed.

6. The UE of claim 3, wherein the configuration includes:
a configuration associated with CLI reporting for sub-band full-duplex (SBFD) symbols; and
a configuration associated with CLI reporting for non-SBFD symbols.

7. The UE of claim 1, wherein the UE is configured with CLI prediction measurement resources, and wherein the at least one processor is configured to cause the UE to determine the occurrence of the CLI report event when another UE is within a threshold distance from the UE.

8. The UE of claim 7, wherein the CLI prediction measurement resources include side-link positioning reference signal (SL-PRS) measurement resources or sensing-based measurement resources.

9. The UE of claim 8, wherein the at least one processor is configured to cause the UE to determine another UE is within the threshold distance from the UE by performing position-based measurements associated with the another UE.

10. The UE of claim 7, wherein the at least one processor is configured to cause the UE to transmit the message to request the UL grant via a dedicated scheduling request (SR) message, dedicated uplink control information (UCI), or a dedicated physical random access channel (PRACH) preamble.

11. The UE of claim 1, wherein the CLI report event includes:
a CLI measurement level is above a configured threshold measurement level;
a CLI measurement level is below a configured threshold measurement level;
a CLI measurement level is an offset above a configured threshold measurement level;
a CLI measurement level is an offset below a configured threshold measurement level;
a distance between the UE and an aggressor UE is above a configured threshold distance; or
a distance between the UE and an aggressor UE is below a configured threshold distance.

12. The UE of claim 1, wherein the at least one processor is configured to cause the UE to determine the occurrence of the CLI report event when one or more CLI measurement levels associated with CLI measurement occasions satisfy one or more conditions associated with the CLI report event within a configured measurement window.

13. The UE of claim 12, wherein the CLI report includes:
a corresponding event index;
one or more corresponding CLI measurement indexes; or
one or more quantized CLI measurement levels.

14. A network entity for wireless communication, comprising:
at least one memory; and
at least one processor coupled with the at least one memory and configured to cause the network entity to:
receive a message from a user equipment (UE) to request an uplink (UL) grant for an event-triggered cross-link interference (CLI) report;
transmit downlink control information (DCI) that schedules resources for the UL grant; and
receive the event-triggered CLI report over the resources scheduled for the UL grant.

15. The network entity of claim 14, wherein the resources for the UL grant include physical uplink shared channel (PUSCH) resources or physical uplink control channel (PUCCH) resources.

16. The network entity of claim 14, wherein the DCI includes a dedicated indicator field that indicates the scheduled resources for the UL grant.

17. The network entity of claim 14, wherein the DCI includes a dedicated channel state information (CSI) request field that is associated with a dedicated CSI trigger state and that indicates the scheduled resources for the UL grant.

18. The network entity of claim 14, wherein the at least one processor is configured to cause the network entity to receive the message to request the UL grant via a dedicated scheduling request (SR) message, dedicated uplink control information (UCI), or a dedicated physical random access channel (PRACH) preamble.

19. A method performed by a user equipment (UE), the method comprising:
determining an occurrence of a cross-link interference (CLI) report event;
transmitting, in response to the occurrence of the CLI report event, a message to request an uplink (UL) grant;
receiving downlink control information (DCI) that schedules resources for the UL grant; and
transmitting a CLI report over the resources scheduled for the UL grant.

20. A method performed by a network entity, the method comprising:
receiving a message from a user equipment (UE) to request an uplink (UL) grant for an event-triggered cross-link interference (CLI) report;
transmitting downlink control information (DCI) that schedules resources for the UL grant; and
receiving the event-triggered CLI report over the resources scheduled for the UL grant.
